(19) United States
(12) Patent Application Publication
(10) Pub. No.: US 2019/0147743 A1
(43) Pub. Date: May 16, 2019

(54) VEHICLE GUIDANCE BASED ON LOCATION SPATIAL MODEL

(71) Applicant: GM GLOBAL TECHNOLOGY OPERATIONS LLC, Detroit, MI (US)

(72) Inventors: Aditya S. Kamini, Bloomfield Hills, MI (US); Jonathan L. Hall, Troy, MI (US); Dario A. Lencina-Talarico, Grosse Pointe Park, MI (US); Chakradhar V. Velvadapu, Northville, MI (US)

(21) Appl. No.: 15/812,187

(22) Filed: Nov. 14, 2017

(51) Int. Cl. G08G 1/14; G08G 1/0969; G06T 7/70; G06T 11/60; G06K 9/00

(52) U.S. Cl. CPC G08G 1/144; G08G 1/0969; G06K 9/00791; G06T 11/60; G06T 7/70

(57) ABSTRACT

A system and method of directing a vehicle operator of a vehicle to a particular area within a mapped location, wherein the method includes: determining a location of the vehicle; obtaining a layout of the mapped location, wherein the layout indicates one or more parking spots for the vehicle and/or one or more vehicle passageways; determining at least one parking spot for the vehicle; receiving video data of an area surrounding the vehicle; displaying the video data on a visual display of the handheld mobile device; generating one or more graphics to present on the visual display, wherein the one or more graphics guide the operator at least partly from an entrance/exit of the mapped location to the at least one parking spot; and displaying the one or more graphics over the camera feed on the visual display.

### INTRODUCTION

The disclosure relates to assisting a vehicle operator in navigating to a particular area within a location.

Many electronic devices and network systems can be used to implement myriad services and provide numerous functionality to users. Such electronic devices can be incorporated into vehicles and can be used to provide the vehicle certain services and/or information. Also, vehicle information, such as the vehicle's location, can be sent from the vehicle to a remote server or database, and from a remote server to a mobile device. The remote network, which can include servers and databases, can use remote network communications, such as via TCP/IP, to provide the vehicle and vehicle users various services, such as providing a car sharing service. Additionally, handheld mobile devices, such as smartphones, can be used in conjunction with such services and may be used to provide a user of the handheld mobile device information pertaining to the vehicle and/or information pertaining to a location at which the vehicle is located.

### SUMMARY

According to a first embodiment, there is provided a method of directing a vehicle operator of a vehicle to a particular area within a mapped location, wherein the method is carried out by a handheld mobile device, wherein the handheld mobile device is associated and/or a part of the vehicle, and wherein the method includes: determining a location of the vehicle using one or more of the following: signals from a global navigation satellite system (GNSS), short-range wireless communications, and/or cellular communication triangulation; obtaining a layout of the mapped location, wherein the layout indicates one or more parking spots for the vehicle and/or one or more vehicle passageways; determining at least one parking spot for the vehicle; receiving video data of an area surrounding the vehicle; displaying the video data on a visual display of the handheld mobile device; generating one or more graphics to present on the visual display, wherein the one or more graphics guide the operator at least partly from an entrance/exit of the mapped location to the at least one parking spot; and displaying the one or more graphics over the camera feed on the visual display.

According to other embodiments, there is provided that of the first embodiment further including any one or more of the following:
wherein the mobile device is a smartphone, a tablet, a wearable mobile device, or an electronic ocular device;
wherein the mobile device is the vehicle;
wherein the layout of the mapped location is an electronically-representative spatial model of the mapped location, and which includes one or more parking spots, passageways, and entrance/exit locations;
wherein the graphics are displayed over the camera feed such that an augmented reality view is provided to the operator and which acts to provide one or more navigational cues that direct the operator along certain passageways within the mapped location;
further comprising the step of obtaining vehicle sensor data, wherein the vehicle sensor data includes a vehicle speed and a vehicle direction, and wherein the one or more graphics are determined based on the obtained vehicle sensor data;
further comprising the step of determining a vehicle position within the mapped location using the vehicle sensor data and the electronically-representative spatial model;
further comprising the step of sensing a radio frequency identifier (RFID) tag and determining whether the RFID tag is associated with the at the at least one parking spot; and/or
further comprising the step of detecting a vehicle ignition or primary mover enable event and, thereafter, carrying out the receiving steps and displaying steps of the method but wherein the one or more graphics guide the operator at least partly from the at least one parking spot to the entrance/exit of the mapped location.

According to a second embodiment, there is provided a method of directing a vehicle operator of a vehicle to a particular area within a mapped location, wherein the method is carried out by a handheld mobile device, wherein the handheld mobile device is associated and/or a part of the vehicle, and wherein the method includes: determining that the vehicle is approaching an entrance/exit of the mapped location using one or more of the following: signals from a global navigation satellite system (GNSS), short-range wireless communications, and/or cellular communication triangulation; obtaining an electronically-representative spatial model of the mapped location, wherein the electronically-representative spatial model conveys spatial information of the mapped location including indications of one or more parking spots for the vehicle and/or one or more vehicle passageways; obtaining information regarding the particular area, wherein the obtained information is based at least in part upon information particular to the vehicle; receiving video data of an area surrounding the vehicle from the handheld mobile device, wherein the handheld mobile device is a set of vehicle electronics included in the vehicle or a personal handheld wireless device mounted within the vehicle, and wherein the handheld mobile device includes at least one camera and at least one visual display; displaying the video data on the at least one visual display of the handheld mobile device; obtaining vehicle sensor data, wherein the vehicle sensor data includes a vehicle speed and a vehicle direction; determining a vehicle position within the mapped location using the vehicle sensor data and the electronically-representative spatial model; generating one or more graphics to display on the visual display based on the vehicle position within the mapped location, wherein the one or more graphics operate to guide the vehicle operator at least partly from the entrance of the mapped location to the particular area within the mapped location; and displaying the one or more graphics over the camera feed on the visual display.

According to other embodiments, there is provided that of the second embodiment further including any one or more of the following:
wherein the handheld mobile device is a smartphone, a tablet, a wearable mobile device, or an electronic ocular device;
wherein the electronically-representative spatial model of the mapped location indicates one or more parking spots, passageways, and entrance/exit locations;
wherein the graphics are displayed over the camera feed such that an augmented reality view is provided to the operator and which acts to provide one or more navigational cues that direct the operator along certain passageways within the mapped location;
wherein the one or more navigational cues indicate a direction for the vehicle operator to travel;
further comprising the step of sensing a radio frequency identifier (RFID) tag and determining whether the RFID tag is associated with the at the at least one parking spot; and/or
further comprising the step of generating one or more graphics to display on the visual display based on the vehicle position within the mapped location, wherein the one or more graphics guide the operator at least partly from the at least one parking spot to the entrance/exit of the mapped location.

### BRIEF DESCRIPTION OF THE DRAWINGS

Exemplary embodiments will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of a handheld mobile device and illustrates some hardware and components of the handheld mobile device;

FIG. 3 is a block diagram depicting a front view of the handheld device of FIG. 2 where the device is depicted as front-facing;

FIG. 4 is a block diagram depicting a rear view of the handheld device of FIG. 2 where the device is depicted as rear-facing; and

FIG. 5 is a flowchart illustrating an embodiment of a method of directing a vehicle operator of a vehicle to a particular area within a location.

### DETAILED DESCRIPTION

The system and methods below enable a handheld mobile device to direct a vehicle operator of a vehicle to a particular area within a location. Many embodiments of the method generally include: determining whether the vehicle is at or approaching a mapped location, obtaining an electronically-representative spatial model of the location, receiving video data, generating one or more augmented graphics, and displaying the one or more augmented graphics over the video data on a visual display. A mapped location can be any location that has an electronically-representative spatial model (including 2D and 3D models). In one scenario, a user may initiate a vehicle-guidance application using a mobile application on a handheld mobile device, such as a smartphone or vehicle electronics (e.g., an infotainment unit). In other embodiments, a user may use a vehicle-guidance application that is stored and executed by the vehicle.

In certain scenarios, cellular or other remote data connections may be impeded due to large structures or underground structures and, thus, navigational information from GNSS satellites or remote servers may be unobtainable at the vehicle. Thus, at least in some embodiments, by anticipatorily downloading spatial map data (e.g., spatial model) of a mapped location that the vehicle is approaching, a vehicle-guidance application can provide navigational cues to a vehicle operator to guide the vehicle operator through the mapped location. The vehicle-guidance application can use certain vehicle sensor data (e.g., steering wheel angle and/or vehicle speed) and imaging information along with the spatial model information to provide the vehicle operator navigational cues so that the user can steer the vehicle to a desired, designated, or particular area within the mapped location, such as a particular parking spot. Through corroboration of this information, a vehicle-guidance application (as discussed above) can be used to provide the user with navigational cues (e.g., in the form of graphics) so that the user can navigate the vehicle to an area within the mapped location without having to rely on long-range wireless signals, which may experience interference in certain structures (e.g., underground parking garages).

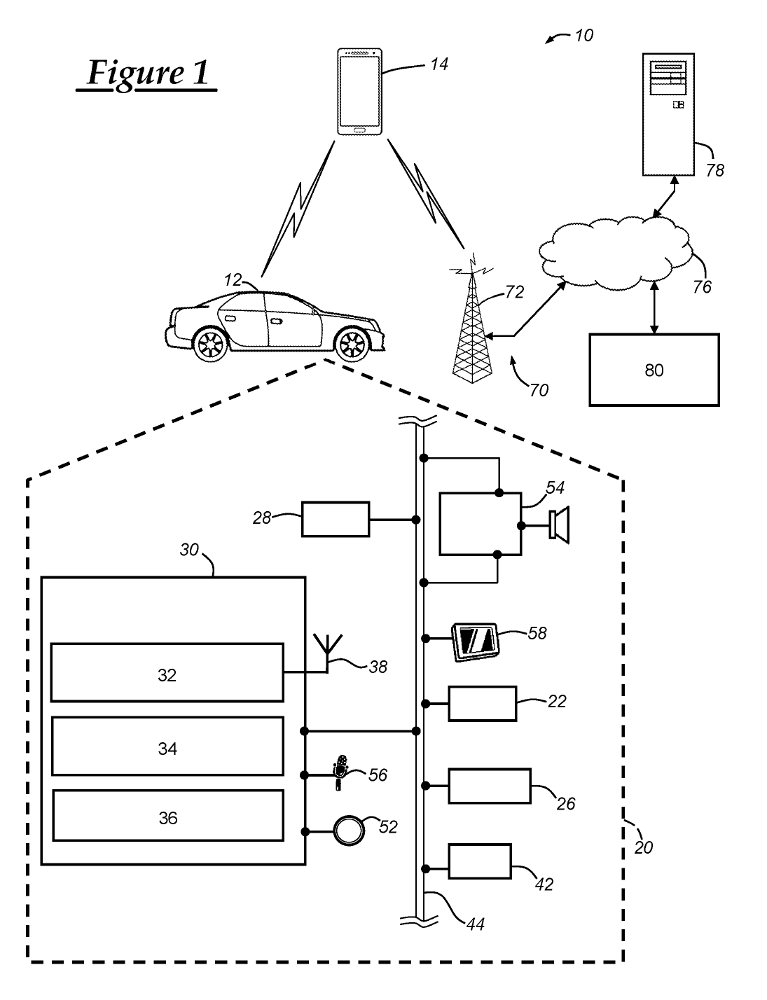

Referring now to FIG. 1, there is shown an operating environment that comprises a communications system 10 and that can be used to implement the method disclosed herein. Communications system 10 generally includes a vehicle 12 with a wireless communications device 30, a handheld mobile device 14, one or more wireless carrier systems 70, a land communications network 76, a computer 78, and a remote facility 80. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which include telematics equipment in vehicle 12). Carrier system 70 can implement any suitable communications technology, including for example GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicles 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof.

Computers 78 (only one shown) can be some of a number of computers accessible via a private or public network such as the Internet. Each such computer 78 can be used for one or more purposes, such as a web server accessible by vehicles 12 or handheld mobile device 14. Other such accessible computers 78 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a car sharing server which coordinates registrations from a plurality of users who request to use a vehicle as part of a car sharing service; or a third party repository to or from which vehicle data or other information is provided, whether by communicating with the vehicles 12, handheld mobile device 14, remote facility 80, or any combination thereof. A computer 78 can also be used for providing Internet connectivity such as DNS services or as a network address server that uses DHCP or other suitable protocol to assign IP addresses to the vehicles 12 or handheld mobile device 14.

In one embodiment, computers 78 can provide information for use in a mobile application that can be executed by the vehicle or a handheld device. The information provided to the mobile application can be information pertaining to the vehicle, the operator, and/or the location of the mobile device or vehicle. For example, the computers 78 can receive a request from the mobile application for particular information, such as for an electronically-representative spatial model of the location. The electronically-representative spatial model of the location can include spatial information of the location including indications of one or more parking spots for the vehicle and/or one or more vehicle passageways.

Remote facility 80 may be designed to provide the vehicle electronics 20 (discussed below) and handheld mobile device 14 with a number of different system back-end functions. For example, remote facility 80 may be used in part to implement a car sharing service. In such a case, remote facility 80 may coordinate registrations of vehicles, store data pertaining to the registrations or other aspects of the car sharing service, and/or provide authentication and authorization data to SRWC devices (e.g., handheld mobile device 14), users, and/or vehicles. The remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 76. A database at the remote facility can store account information such as subscriber authentication information, vehicle identifiers, profile records, behavioral patterns, and other pertinent subscriber information. Data transmissions may also be conducted by wireless systems, such as IEEE 802.11x, GPRS, and the like. Although the illustrated embodiment has been described as it would be used in conjunction with a manned remote facility 80 using a live advisor, it will be appreciated that the remote facility can instead utilize a VRS as an automated advisor or, a combination of the VRS and the live advisor can be used. The remote facility 80 or computer 78 can include numerous servers and databases that can be used in conjunction with one or more steps of certain embodiments of the method discussed herein. In such embodiments, the remote facility 80 or computer 78 can store vehicle information in one or more databases (or memory devices) and can communicate with a vehicle-guidance application on the handheld mobile device 14, as discussed in more detail below.

In one embodiment, remote facility 80 can include a vehicle parking system that includes information pertaining to certain vehicle parking facilities (e.g., parking structures, parking lots), such as electronically-representative spatial model of the parking facilities. Also, the remote facility can include parking information for particular vehicles, such as certain designated parking spots or locations in which the particular vehicles may access or park at. For example, based on receiving location information and a vehicle identification number (VIN) from a vehicle or handheld mobile device that is associated with the vehicle, the remote facility 80 may query one or more databases located therein and obtain information pertaining to the authorization of the vehicle at the particular location in which it is located (or at which was specified in the received location information). Other information may be sent to the handheld mobile device (e.g., handheld wireless device 14, vehicle electronics 20), such as which parking spots are presently occupied, which parking spots are presently available for occupation by the vehicle, and/or unauthorized/authorized areas in which the vehicle may travel. The remote facility 80 can be connected to certain locations that provide information pertaining to the location, such as whether certain parking spots are presently occupied. The remove facility 80 can then send such information to the vehicle 12 or mobile device 14.

Vehicle 12 (only one is shown in FIG. 1) is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and includes a wireless communications device 30, a GNSS module 22, camera(s) 26, sensors 28, other VSMs 42, and numerous other components and devices. Some or all of the different vehicle electronics may be connected for communication with each other via one or more communication busses, such as bus 44. Communications bus 44 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

The vehicle 12 can include numerous vehicle system modules (VSMs) as part of vehicle electronics 20, such as the GNSS module 22, camera(s) 26, sensors 28, wireless communications device 30, vehicle user interfaces 52-58, as will be described in detail below. The vehicle 12 can also include other VSMs 42 in the form of electronic hardware components that are located throughout the vehicle and, which may receive input from one or more sensors and use the sensed input to perform diagnostic, monitoring, control, reporting, and/or other functions. Each of the VSMs 42 is preferably connected by communications bus 44 to the other VSMs, as well as to the wireless communications device 30, and can be programmed to run vehicle system and subsystem diagnostic tests. One or more VSMs 42 may periodically or occasionally have their software or firmware updated and, in some embodiments, such vehicle updates may be over the air (OTA) updates that are received from a computer 78 or remote facility 80 via land network 76 and communications device 30. As is appreciated by those skilled in the art, the above-mentioned VSMs are only examples of some of the modules that may be used in vehicle 12, as numerous others are also possible.

Wireless communications device 30 is capable of communicating data via short-range wireless communications (SRWC) or via cellular communications. As shown in the exemplary embodiment of FIG. 1, wireless communications device 30 includes a wireless chipset 32, a processor 34, memory 36, and one or more antennas 38 (only one is shown for illustrative purposes). Also, wireless communications device 30 can be directly connected to one or more vehicle user interfaces, such as microphone 56 and/or pushbutton 52. In one embodiment, wireless communications device 30 may be a standalone module or, in other embodiments, device 30 may be incorporated or included as a part of one or more other vehicle system modules, such as a center stack module (CSM), body control module, an infotainment module, a telematics module, a head unit, and/or a gateway module. In some embodiments, the device 30 can be implemented as an OEM-installed (embedded) or aftermarket device that is installed in the vehicle.

Wireless communications device 30 can be configured to communicate wirelessly according to one or more wireless protocols, including short-range wireless communications (SRWC) such as any of the IEEE 802.11 protocols, Wi-Fi™ WiMAX™, ZigBee™, Wi-Fi Direct™, Bluetooth™, Bluetooth™ Low Energy (BLE), or near field communication (NFC). The short-range wireless communication circuit or chipset 32 enables the wireless communications device 30 to transmit and receive SRWC, such as BLE. The SRWC circuit may allow the device 30 to connect to another SRWC device. As used herein, a short-range wireless communications (SRWC) device is a device capable of SRWC. Additionally, in many embodiments, the wireless communications device may contain a cellular chipset thereby allowing the device to communicate via one or more cellular protocols, such as those used by cellular carrier system 70. In other embodiments, a separate telematics unit can be provided and used to carry out cellular communications.

The vehicle may use the wireless communications device 30 to detect other SRWC devices, such as handheld mobile device 14. A connection between the wireless communications device 30 and one or more devices 14 may allow for the operation of various vehicle-device functionality, and may be established when the handheld mobile device 14 comes within a predetermined distance of the vehicle. Vehicle-device functionality refers to any function of the vehicle that may be complimented, improved, supported, or carried out through a handheld mobile device; any function of the handheld mobile device that may be complimented, improved, supported, or carried out through the vehicle; or any other function that may be carried out using the vehicle and one or more handheld mobile devices. For example, vehicle-device functionality can include using the handheld mobile device to provide the vehicle with a contact list that may be displayed on visual display 58, audio/visual media content to be played via speakers 54 or display 58, navigational information (e.g., start and/or end locations), and/or vehicle commands or instructions that direct the vehicle to perform some operation. Other examples of vehicle-device functionality include using the vehicle electronics to provide the handheld mobile device with hands-free calling, such as through use of vehicle-user interfaces to place, receive, and carry out voice calls; sending information to the handheld mobile device, such as geographical information to the handheld mobile device (such as information obtained from the GPS module 22) or vehicle diagnostic information or codes; and carrying out commands received at the vehicle from the handheld mobile device.

Upon detection of a SRWC device (e.g., handheld mobile device 14) or receipt of a wireless message, the wireless communications device 30 may communicate with the SRWC device by transmitting and receiving one or more wireless messages. These messages may include authenticating or otherwise verifying the identity of the SRWC device which sent (or ostensibly sent) the wireless message, authorizing the SRWC device using one or more authorization techniques (as discussed more below), and/or pairing the SRWC device and the wireless communications device 30 (e.g., such as through Bluetooth™ or Bluetooth™ Low Energy pairing). Additionally, upon detection of a SRWC device, the wireless communications device 30 may determine whether the wireless communications device 30 is bonded to the SRWC device. As used herein, “bonded” means that two devices (e.g., the wireless communications device 30 and handheld mobile device 14) have previously been paired and each stores a common secret key, identifier, and/or other information that allows the devices to subsequently establish a new Bluetooth™ connection without pairing (i.e., exchanging security codes or keys). “Bluetooth™ bonded” refers to devices that are bonded using Bluetooth™ as the SRWC. As used herein, Bluetooth™ refers to any of the Bluetooth™ technologies, such as Bluetooth™ Low Energy (BLE), Bluetooth™ 4.1, Bluetooth™ 4.2, Bluetooth™ 5.0, and other Bluetooth™ technologies that may be developed.

Once a connection is established between the wireless communications device 30 and the handheld mobile device, such as mobile device 14, wireless messages may be sent between the vehicle and the handheld mobile device. These wireless messages may be sent by using a mobile application (e.g., vehicle-guidance application) included on the SRWC device and a complimentary application installed on the vehicle. Also, these messages and/or the SRWC that sent these wireless messages may be authenticated and/or authorized by the vehicle. The authorization and/or authentication of the handheld mobile device (or other SRWC device) may include verifying the identity of the handheld mobile device and/or the user of the handheld mobile device, as well as checking for authorization of the handheld mobile device and/or the user of the handheld mobile device. This verification may include comparing a key (e.g., a string or array of bits) included in the connection request (or subsequent message) with a key that the vehicle obtained from a remote facility 80.

The communications between the vehicle and the handheld mobile devices may allow for functionality of the smartphone to be used by the vehicle electronics, or vice versa. For example, in the case where the handheld mobile device is a cellular-enabled smartphone, received calls at the smartphone may be carried out through the audio system 54 and/or through use of microphone 56 of the vehicle electronics 20. This may be done so through the phone sending all received audio data or signals to the wireless communications device 30, which then may use bus 44 to send the audio signals to audio system 54. Likewise, video received at the smartphone 14 may be sent to the visual display 58 via the wireless communications device 30. Also, audio received at microphone 56 in the vehicle electronics may be sent to the smartphone 14 via wireless communications device 30.

Wireless communications device 30 may be in communication with one or more remote networks via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30 via, for example, a telematics unit included in the vehicle. In one embodiment, the communications device 30 may also include a cellular chipset or be communicatively coupled to a device comprising a cellular chipset such as a telematics unit. In either event, communications device 30 may, via a cellular chipset, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 34 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 34 executes various types of digitally-stored instructions, such as software or firmware programs stored in memory 36, which enable the device 30 to provide a wide variety of services. Memory 36 may include RAM, other temporary powered memory, any non-transitory computer-readable medium (e.g., EEPROM), or any other electronic computer medium that stores some or all of the software needed to carry out the various external device functions discussed herein.

Global Navigation Satellite System (GNSS) or global position system (GPS) module 22 receives radio signals from a constellation of GNSS satellites (not shown). From these signals, the module 22 can determine vehicle position which may enable the vehicle to determine whether it is at a known location, such as home or workplace. Moreover, GNSS module 22 can provide this location data to wireless communications device 30, which can then use this data to identify known locations, such as a vehicle operator's home or workplace, as well as to carry out the method described herein. Additionally, GNSS module 22 may be used to provide navigation and other position-related services to the vehicle operator. Navigation information can be presented on the display 58 (or other display within the vehicle) or can be presented verbally such as is done when supplying turn-by-turn navigation. The navigation services can be provided using a dedicated in-vehicle navigation module (which can be part of GNSS module 22), or some or all navigation services can be done via a telematics unit installed in the vehicle, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 78, for other purposes, such as fleet management and/or for use in a car sharing service. Also, new or updated map data can be downloaded to the GNSS module 22 from the remote facility 80 via a vehicle telematics unit. Other satellite navigation systems may be used as well.

Cameras 26 (only one shown) may be digital cameras that are incorporated into vehicle 12 and that digitally capture images and videos surrounding the vehicle, such as areas located in the rear of the vehicle, to the sides of the vehicle, and/or in front of the vehicle. In one embodiment, multiple cameras may be located on vehicle 12 such that the cameras can capture images or video of the same area or at least part of the same area. In yet another embodiment, a stereo camera (or stereoscopic camera) or other camera with multiple lenses or separate image sensors may be used. In either of such embodiments, the camera(s) may be used to capture more information pertaining to the captured area, such as three-dimensional characteristics (e.g., distances of objects in the captured area), as will be known by those skilled in the art.

In some embodiments, the images or video captured by the camera may be immediately displayed on visual display 58 thereby allowing the user to view the area that is being captured by the camera on the display. Accordingly, the vehicle 12 may overlay or dispose certain graphical objects over the displayed camera feed, as will be discussed more below. In addition, the cameras may each include a camera flash (not shown). Also, the camera or video feed may be streamed to another device, such as handheld mobile device 14, computers 78, or a server at remote facility 80.

Sensors 28 (only one shown) can be any vehicle sensors known to those skilled in the art and can include: vehicle speed or wheel speed sensors, steering wheel angle sensors, brake sensors, ignition sensors, transmission sensors, torque sensor, positional sensors (e.g., to measures yaw or pitch), accelerometer, throttle position sensors, etc. In one embodiment, the vehicle can obtain sensor data and use this data to aid the vehicle-guidance application. For example, the vehicle can use wheel speed sensors and steering wheel angle sensors to determine vehicle direction and movement away from a known start location through use of a dead reckoning technique. Other navigation techniques may also be employed by the vehicle through use of one or more sensors 28.

Vehicle electronics 20 also includes a number of vehicle user interfaces that provide vehicle occupants with a means of providing and/or receiving information, including pushbutton(s) 52, audio system 54, microphone 56, and visual display 58. As used herein, the term “vehicle user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, or control input. Audio system 54 provides audio output to a vehicle occupant and can be a dedicated, stand-alone system or part of the primary vehicle audio system. According to the particular embodiment shown here, audio system 54 is operatively coupled to both vehicle bus 44 and an entertainment bus (not shown) and can provide AM, FM and satellite radio, CD, DVD and other multimedia functionality. This functionality can be provided in conjunction with or independent of an infotainment module. Microphone 56 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 58 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

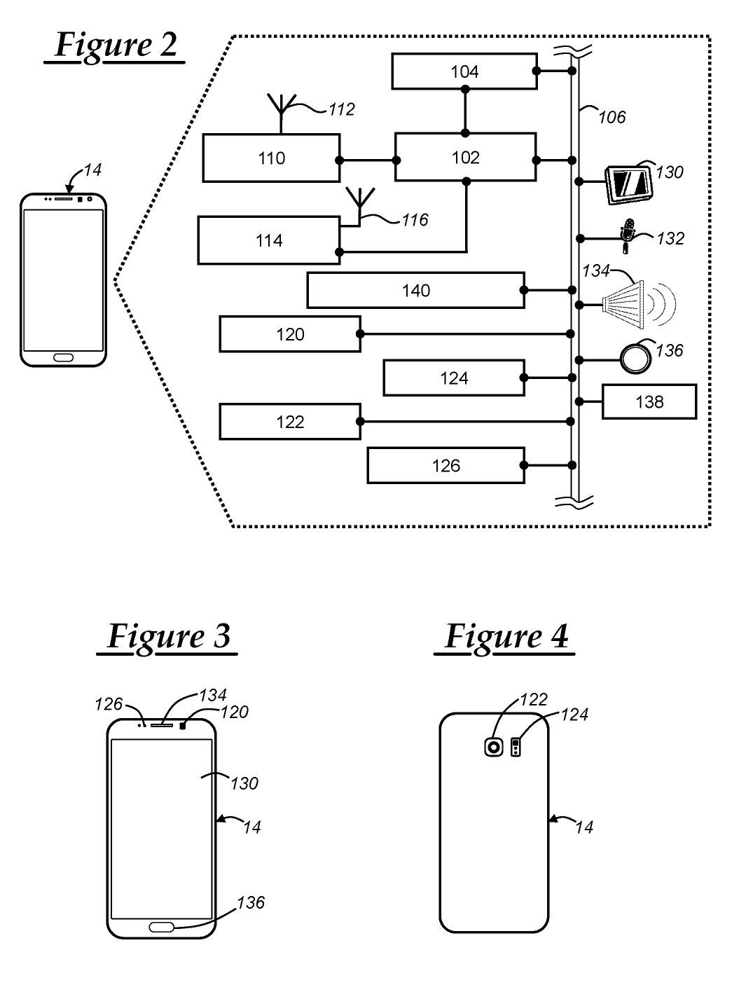

With reference to FIGS. 2-4, there is shown a schematic view of the hardware and components of a handheld mobile device 14 (FIG. 2), along with a front view (FIG. 3) and a back view (FIG. 4) of a handheld mobile device 14. Device 14 is shown as a smartphone having cellular telephone capabilities; however, in other embodiments, device 14 may be a tablet, a wearable electronic device (e.g., a smartwatch or an electronic ocular device), or any other suitable device. As used herein, a handheld mobile device is a device that is capable of network communications and that is portable by a user, such as a wearable device (e.g., a smartwatch), an implantable device, or a handheld device (e.g., a smartphone, a tablet, a laptop). The mobile device includes: hardware, software, and/or firmware enabling cellular telecommunications and/or short range wireless communications (SRWC), as well as other wireless device functions and applications. The hardware of mobile device 14 comprises a processor 102, memory 104, wireless chipsets/circuits 110,114, antennas 112,116, cameras 120,122, GNSS module 138, accelerometer 140, and various user-device interfaces.

Processor 102 can be any type of device capable of processing electronic instructions and can execute such instructions that may be stored in memory 104, such as those devices and types of instructions discussed above with respect to processor 32 in wireless communications device 30. For instance, processor 102 can execute programs or process data to carry out at least a part of the method discussed herein. The processor may also execute an operating system for the handheld device, such as Android™, iOS™ Microsoft™ Windows™, and/or other operating systems. The operating system may provide a user interface and a kernel, thereby acting as a central control hub that manages the interfacing between the hardware and software of the device. Moreover, the operating system may execute mobile applications, software programs, and/or other software or firmware instructions. In one embodiment, the processor can execute a vehicle-guidance application that enables a user to make vehicle reservations and to assist a user in locating potential vehicles to reserve or vehicles that the user has reserved.

Memory 104 may include RAM, other temporary powered memory, any non-transitory computer-readable medium (e.g., EEPROM), or any other electronic computer medium that stores some or all of the software needed to carry out the various external device functions discussed herein. In other embodiments, memory 104 may be a non-volatile memory card, such as a Secure Digital™ (SD) card, that is inserted into a card slot of device 14.

The processor 102 and/or memory 104 may be connected to a communications bus 106, which allows for the communication of data between the processor and other components of the device 14, such as cameras 120,122, camera flash 124, LED indicator 126, visual display 130, microphone 132, speaker 134, pushbutton 136, GNSS module 138, accelerometer 140, and various other components. The processor 102 may provide processing power for such components and/or may, through the operating system, coordinate functionality of the components, while the memory 104 may allow for storage of data that may be usable by such components. For example, the processor may run the primary operating system for the device 14, which may include displaying a graphical user interface (GUI) on a touchscreen display 130. In such an example, the GUI may include the display of images that may be stored in memory 104. The mobile device processor and software stored in the memory also enable various software applications, which may be preinstalled or installed by a user or by a manufacturer. This may include an application (e.g., the vehicle-guidance application) that can allow the device 14 to provide visual cues to a vehicle operator such that the vehicle can drive the vehicle to a designated or particular area, such as a particular parking spot within a parking facility. The vehicle-guidance application can be used with remote computer 78, remote facility 80, and/or vehicle 12. This vehicle-guidance application may use one or more of the components of the device 14, such as display 130, front-facing camera 120, rear-facing camera 122, GNSS module 138, accelerometer 140, and speaker 134, as will be discussed in more detail below.

The handheld mobile device 14 includes a short range wireless communications (SRWC) chipset 110 and SRWC antenna 112, which allows it to carry out SRWC, such as any of the IEEE 802.11 protocols, WiMAX™, ZigBee™, Wi-Fi Direct™, Bluetooth™ Bluetooth™ Low Energy (BLE), or near field communication (NFC). The SRWC chipset may allow the device 14 to connect to another SRWC device.

Additionally, handheld mobile device 14 contains a cellular chipset 114 thereby allowing the device to communicate via one or more cellular protocols, such as GSM/GPRS technology, CDMA or CDMA2000 technology, and LTE technology. Device 14 may communicate data over wireless carrier system 70 using the chipset 114 and cellular antenna 116. Although the illustrated embodiment depicts a separate chipset and antenna for SRWC and cellular communications chipsets, in other embodiments, there may be a single antenna for both chipsets, a single chipset and multiple antennas, or both a single chipset and a single antenna. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Global Navigation Satellite System (GNSS) or global position system (GPS) module 138 receives radio signals from a constellation of GNSS satellites (not shown). From these signals, the module 138 can determine the position of the handheld mobile device 14, which may enable the device to determine whether it is at a known location, such as home or workplace. The GNSS module 138 may be similar to the GNSS module 22 provided in the vehicle electronics, and may provide similar functionality to the mobile device 14.

Cameras 120 and 122 may be digitals cameras that are incorporated into device 14 and that enable device 14 to digitally capture images and videos. As shown in FIG. 3, camera 120 may be a front-facing camera, meaning that the camera faces an area in front of the front-side of the device 14, the front side being, in many embodiments, the side with the main visual display. Since an operator of a device 14 generally holds or positions such a device so that the visual display is in view, camera 120 in such an arrangement may face the operator, thereby allowing the operator to capture images and video of the operator (e.g., selfies) and/or behind and surrounding the operator. As shown in FIG. 4, camera 122 is a rear-facing camera, meaning that the camera faces an area away from the front side of the device. Thus, in such an arrangement of usual use of the mobile device as described above, the camera may capture images or video of an area in front of the operator. In one scenario, the mobile device 14 can be mounted on a vehicle dashboard (or elsewhere on the vehicle) in a manner such that the visual display 130 faces a vehicle operator and such that the rear-facing camera captures images or video from an area in front of the vehicle. In such a scenario, the device 14 can execute the vehicle-guidance application that can be used to direct the vehicle operator to a particular or designated area within a location, such as to one or more parking spots within a parking facility.

In another embodiment, multiple cameras may be located on the handheld mobile device 14 such that the cameras capture images or video of the same area or at least part of the same area. In yet another embodiment, a stereo camera (or stereoscopic camera) or other camera with multiple lenses or separate image sensors may be used. In either of such embodiments, the camera(s) may be used to capture more information pertaining to the captured area, such as three-dimensional characteristics (e.g., distances of objects in the captured area), as will be known by those skilled in the art.

In some embodiments, the images or video captured by the camera may be displayed on visual display 130 even when the user is not presently capturing images or recording videos to be stored, thereby allowing the user to view the area that is being captured by the camera on the display. Accordingly, the device 14 may overlay or dispose certain graphical objects over the displayed camera feed, as will be discussed more below. In addition, the cameras may each include a camera flash, such as camera flash 124 which is shown in FIG. 4 to be primarily for use with rear-facing camera 122; however, such camera flash 124 or other camera flashes (not shown) may be used for other purposes such as for providing light in dark or low-light environments or providing a warning or other indicator to gain the attention of nearby persons.

Furthermore, the cameras may, during operation of the vehicle-guidance application, record and/or store images that have been captured in memory 104. In one embodiment, the camera may capture and store video whenever the application is running. The device 14 may then delete video that is older than a predetermined amount of time (e.g., 5 minutes) unless an operator specifically provides an indication that the video should be saved. If a user does not indicate that he/she would like to save the video and the video is older than a predetermined amount of time old, the camera may delete the video and free up memory. In other embodiments, a user may desire to record video or images for the entire trip or time the application is running.

Handheld mobile device 14 also includes a number of user-device interfaces that provide users of the mobile device with a means of providing and/or receiving information. As used herein, the term “user-device interface” broadly includes any suitable form of electronic device, including both hardware and software components, which is located on the device and enables a user of the device to communicate with the device. Such examples of user-device interfaces include indicator 126, visual display (or touchscreen) 130, microphone 132, speaker 134, and pushbutton(s) 136. Indicator 126 may be one or more light indicators, such as light emitting diodes (LEDs), and, in some embodiments, may be located on a front-face of the device 14, as shown in FIG. 3. The indicator may be used for numerous purposes, such as to indicate to an operator of device 14 that there is a new notification on the device. Visual display or touch screen 130 is, in many embodiments, a graphics display, such as a touch screen located on the front face of the device 14, as shown in FIG. 3, and can be used to provide a multitude of input and output functions. Microphone 132 provides audio input to the device 14 to enable the user to provide voice commands and/or carry out hands-free calling via the wireless carrier system 70. Speaker 134 provides audio output to a vehicle occupant and can be a dedicated, stand-alone system or part of the primary device audio system. The pushbuttons 136 (only one shown) allow manual user input to provide other data, response, or control input. Other pushbuttons may be located on the device 14, such as a lock button on the side of the device 14, up and down volume controls, camera buttons, etc. Additionally, as those skilled in the art will appreciate, the pushbutton(s) do not need to be dedicated to a single functionality of the device 14, but may be used to provide interfacing means for a variety of different functionality. Various other vehicle user interfaces can also be utilized, as the interfaces of FIGS. 2-4 are only an example of one particular implementation.

The handheld mobile device 14 can include image processing techniques that can be used to recognize one or more objects that are in the field of view of cameras 120 and/or 122. Such techniques may be known to those skilled in the art, and may include recognizing vehicles, street signs, other signs (e.g., building signs), traffic signals, pedestrians, sidewalks, roadways, and/or other objects within the field of view of the cameras.

Also, the handheld mobile device 14 can include a vehicle-guidance application that can be used to provide a vehicle-guidance interface, which can present the user (or vehicle operator) with an augmented video feed that can be used to direct the vehicle operator to a particular or designated area within the location. In one embodiment, a user can start the application using an operating system included as part of the mobile device 14. In another embodiment, the device may realize or determined that vehicle 12 is approaching a known location, such as a particular parking facility. Upon this realization or determination, the device 14 may carry out certain processes, such as the method discussed below.

After authentication/authorization, certain information regarding the vehicle may be sent to a remote facility, such as a spatial model request, which is a request to obtain an electronically-representative spatial model of the location at which the vehicle has arrived or is about to arrive. Other information may be requested such as information pertaining to a particular location near or around the vehicle. Also, other vehicle information or attributes may be included in the response. Vehicle attributes can include a model of the vehicle, a make of the vehicle, a model year of the vehicle, a fuel efficiency metric of the vehicle, an engine type of the vehicle, a safety rating of the vehicle, a storage capacity of the vehicle (e.g., trunk size, bed size), SRWC capabilities of the vehicle, height of the vehicle, length of the vehicle, passenger capacity of the vehicle, type of transmission of the vehicle (e.g., automatic, manual), type of fuel of the vehicle, engine attributes of the vehicle (e.g., number of cylinders, engine displacement volume, horsepower, torque, presence and/or type of turbochargers), and/or other various vehicle attributes that are known to those skilled in the art.

In response to the spatial model request, the remote server (e.g., a server at remote facility 80 or computer 78) can then generate a spatial model response. This response may be generated based on the spatial model request and in conjunction with data stored in a database at the remote facility 80 or computer 78. For example, the remote server can determine which parking spots or areas are available for occupation by the vehicle, which spots or areas are not available for occupation by the vehicle, which spots or areas the vehicle is permitted to occupy, which spots or areas the vehicle is not permitted to occupy, and/or a variety of other information. In the case where no parking spots or areas are available, the spatial model response can include data or information indicating that there are no parking spots or areas for the vehicle to occupy at the location (e.g., parking facility). The application on mobile device 14 may then present a notification to the user.

Once the spatial model response is received at the handheld mobile device 14, device 14 can use the information or data contained in the spatial model response to determine an area within the location in which to direct the vehicle operator. For example, the vehicle may use the electronically-representative spatial model of the location and data pertaining to designated parking spots or areas in which the vehicle may park at the present time. The device 14 may then use camera 122 to capture images or video to be presented on the visual display 130 of device 14. Also, certain objects may be recognized by the vehicle-guidance application and may be used to orient the device's position within the location. In certain embodiments where GNSS signals may not be readily received, such as in a parking garage, the visual cues (e.g., certain objects in the parking garage that are captured by the camera 122) may be used in conjunction with the spatial model of the location to generate directions or provide guidance to the vehicle operator such that the vehicle operator may steer or drive the vehicle to the designated or particular area. The vehicle can then generate graphics and display such graphics over the video or camera feed on the visual display 130. Any of these graphics may be overlaid, disposed, superimposed, or otherwise displayed over the camera or video feed on visual display 130 of handheld mobile device 14.

The graphics that are displayed on the camera feed or video feed can be associated with an object in the field of view of the camera feed or may be associated with a location that corresponds to the information represented in the graphic. For example, the vehicle information response may contain location information pertaining to multiple parking spots or areas. The application that provides the vehicle-guidance interface can use this vehicle information and information of the handheld mobile device (e.g., the location and heading of device 14) to position the graphics over the camera feed and in a position that corresponds to the parking spot.

In some embodiments, the graphics that are generated may be presented on a touchscreen 130 and may be configured to perform an operation upon a user pressing or clicking on the region or area of the screen in which the graphic resides. For example, when a user touches an area on touchscreen 130 where a graphic is displayed, detailed information pertaining to that graphic (or object that it represents) can be obtained and/or presented on touchscreen 130 or otherwise presented to the user, such as via speaker 134 or other user interfacing means.

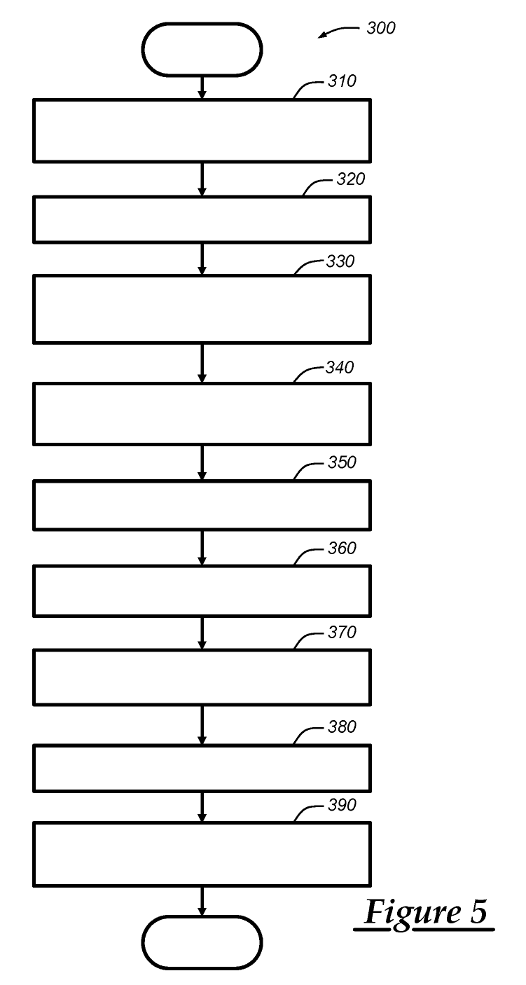

With reference to FIG. 5, there is shown an embodiment of a method 300 of directing a vehicle operator of a vehicle to a particular area within a location. Method 300 may be carried out by the vehicle using vehicle electronics, by another mobile device (e.g., smartphone 14), or by a combination of the vehicle and another mobile device. The term “mobile device,” as used in the following paragraphs describing method 300, refers to the vehicle, mobile device 14, any other mobile device, or any combination thereof.

The method 300 begins with step 310, where it is determined that the vehicle is approaching an entrance of the location. In many embodiments, the location may be a parking garage or a parking lot, as discussed above. The mobile device may have information pertaining to certain mapped locations (e.g., parking garages) stored on memory 36 (or other vehicle memory) and may compare the vehicle's location to the mapped locations to determine if the vehicle is at, near, or approaching one of the mapped locations. In the case where the mobile device carrying out the method 300 is a handheld mobile device, the handheld mobile device may use its own location to compare against the mapped locations or may query the vehicle for its location.

Or, in other embodiments, the mobile device may query a remote server (e.g., computer 78 or remote facility 80) for information regarding whether the vehicle is at, near, or approaching a certain mapped location. This query may be automatically initiated by the mobile device or may be initiated upon the occurrence of a triggering event by the user or vehicle, such as by a decrease in average vehicle speed or a press of a pushbutton 52 or 136 by the user.

In any of the embodiments discussed above, it may be determined that the vehicle is approaching an entrance of the location using signals from a global navigation satellite system (GNSS) (e.g., GNSS 22, GNSS 138), short-range wireless communications (SRWC) (e.g., using wireless circuit 32 and/or SRWC circuit 110), and/or cellular communication triangulation (e.g., using wireless circuit 32 and/or wireless chipset 114). If it is determined that the vehicle is at, near, or approaching a mapped location, the method 300 continues to step 320.

In step 320, an electronically-representative spatial model of the mapped location that the vehicle is at, near, or approaching is obtained. In at least one embodiment, the electronically-representative spatial model conveys spatial information of the location including indications of one or more parking spots for the vehicle and/or one or more vehicle passageways. Also, the spatial model can include entrance/exit locations of the mapped location such as points at which the vehicle or operator may enter or exit the mapped location. For example, in a scenario where the mapped location is a parking garage, the spatial model can include passageways (i.e., pathways that the vehicle may travel on) and parking spots, as well as whether those spots are occupied or whether the vehicle has permission/authorization to park in certain spots (see also step 330). The spatial model can be obtained from memory 36 of the vehicle (and sent via SRWC to handheld device 14) or may be obtained from a remote server, such as from computer 78 or a server at remote facility 80. Once this information is obtained, the spatial model may be stored in memory, such as memory 36 and/or memory 104. The method 300 continues to step 330.

In step 330, information regarding the particular area is obtained. The particular area may be a specific parking spot for the vehicle or an area of the mapped location where the user is trying to navigate to (e.g., which can be determined based on receiving an address or other information from the mobile device via user-device interfaces or vehicle-user interfaces). In one embodiment, the area of the mapped location may be an area that the vehicle or vehicle operator has authorization to access or park the vehicle. This information can be obtained from a local memory device, such as memory 36 or memory 104, or may be obtained from a remote server. In the latter case, the mobile device (e.g., handheld mobile device 14 or vehicle 12) may query the remote server by sending a location information request and receiving a location information response message. The request can include certain information pertaining to the vehicle, user of the vehicle, or handheld mobile device, and the response can be based on any of this information included in the location information request. In one scenario, information regarding certain parking spots that are available can be obtained. The method 300 continues to step 340.

In step 340, video data of an area surrounding the vehicle from the handheld mobile device is received. The video data can be received from one or more cameras 26 included in the vehicle electronics or from one or more cameras 120,122 included on the handheld mobile device 14. In one embodiment, video data is obtained by a front-facing camera 26 that is installed on the front of vehicle 12 and that faces an area in front of the vehicle. The video data can be stored in memory 36 or sent to another device, such as handheld mobile device 14, via SRWC or other communication means. In another embodiment, handheld mobile device 14 is mounted on a dashboard of a vehicle such that rear-facing camera 122 faces an area in front of the vehicle and screen 130 faces a vehicle operator. The camera 122 can obtain video data of the area in front of the vehicle and may store this information in memory 104 and/or may send this information to vehicle 12 via SRWC.

Also, the video data may be processed to obtain information regarding the area in front of the vehicle (i.e., within the field of view of the camera). Using certain image processing applications or software, certain objects that are within the video data can be recognized and used by the vehicle-guidance application to determine or corroborate vehicle position within the mapped location. For example, certain signs (e.g., “EXIT” or “Zone 1”) can be recognized through image processing techniques and then used, in conjunction with vehicle sensor data and the spatial model, to generate navigational graphics (step 280) or other navigational aids, which can be used to help a vehicle operator navigate to the particular destination location within the mapped location. The method 300 continues to step 350.

In step 350, the video data is displayed on a screen of the mobile device. In one embodiment, the video data is displayed on touchscreen 130 of the handheld mobile device 14 and, in another embodiment, the video data is displayed on display 58 of the vehicle. The video data can be displayed in a streaming manner such that the video data is displayed as soon as it is received and sent to the display. Such a display of the video data in a continuous and streaming manner may be referred to as a “camera feed” or “video feed.” The method 300 then continues to step 360.

In step 360, vehicle sensor data is obtained, wherein the vehicle sensor data includes a vehicle speed and a vehicle direction. In other embodiments, other vehicle sensor data can be obtained, such as vehicle throttle information or braking information. This sensor data can be obtained from sensors 28 and sent to processor 34 or handheld mobile device 14 via SRWC. The method 300 continues to step 370.

In step 370, a vehicle position within the mapped location is determined using the vehicle sensor data and the electronically-representative spatial model. In one embodiment, once the spatial model is received, the handheld mobile device 14 can continuously keep track of the vehicle's position within the location through storing a vehicle current position value in memory and advancing the vehicle current position value based on vehicle sensors through use of a dead reckoning technique. For example, using vehicle speed and a vehicle clock, the vehicle can keep track of where the vehicle is within the location by referencing the spatial map in accordance with the distance and direction the vehicle has driven, which can be determined based on one or more vehicle sensors.

In some embodiments, the vehicle can use camera sensors, such as those of mobile device 14 or digital cameras installed on the vehicle, that can be used to recognize one or more objects surrounding the vehicle. These objects can be processed using various image processing techniques (e.g., computer vision techniques) and in conjunction with the spatial model to determine or help corroborate the vehicle's position at the mapped location. For example, the vehicle may use sensors 28 according to a dead reckoning technique, such as the one discussed above, and may use images from one or more cameras in conjunction with the spatial model of the mapped location to determine the location of the vehicle within the mapped location. While this and other similar methods, many of which are known to those skilled in the art, may be used in the absence of GNSS signals (e.g., if the GNSS satellite signals are interfered with such that the GNSS module 22 and/or GNSS module 138 cannot receive the GNSS signals), in other embodiments, GNSS signals may be used to corroborate and/or determine the vehicle's location. The method 300 continues to step 380.

In step 380, one or more graphics to display on the visual display are generated. The one or more graphics can operate to guide the vehicle operator at least partly from the entrance of the mapped location to the particular area within the mapped location. Such graphics that aid in the navigation of a vehicle operator can be referred to as navigational aid graphics. These navigational aid graphics can take the form of a variety of shapes, sizes, images, colors, etc., and can be presented over the displayed video data such that an augmented reality view is created, which can provide, at least in some embodiments, an improved navigational experience. In some scenarios, access to remote servers or GNSS signals may be impeded by one or more structures at the mapped location and, thus, the vehicle operator may instead rely on local vehicle information (e.g., speed, steering wheel angle), sensor data (e.g., vehicle sensors, video data from one or more cameras), and the mapped spatial model to provide the user with navigational information so that the user can drive or steer the vehicle to a particular location within the mapped location, such as a particular or designated parking spot. The graphical information can be generated based on the vehicle sensor data, the spatial model, the vehicle current position value, the video data (including information obtained from the video data (see step 340)), and/or other data at the mobile device. In one embodiment, the mobile device can keep track of the vehicle's position within the mapped location and then can use this information to generate the appropriate graphics, which can be used to provide navigational cues to the operator (e.g., text stating “TURN RIGHT”, depicting a right pointing arrow). The method 300 then continues to step 390.

In step 390, the one or more graphics are displayed over the camera feed on the visual display. The graphics can be associated with an object in the field of view of the camera feed (e.g., such as a vehicle) or may be associated with a location that corresponds to the information represented in the graphics. The graphics can be used to supplement the video data such that the graphics aid a user in visualizing one or more passageways, signs, parking spots, or other objects or areas within the field of view 160 of camera 122 or around the vehicle 12. In such a case, the graphics in conjunction with the video data provide the user with an augmented reality that can facilitate a user's experience in navigating to a particular or designated area within the mapped location. The method 300 then ends.

The method 300 can be carried out until the vehicle-guidance application is terminated by the operator, or until the vehicle arrives at the particular location (e.g., a designated parking spot). Also, when the vehicle is nearing the particular location, one or more additional steps may be carried out. In one embodiment, the parking spot may include a radio frequency identification (RFID) tag that indicates the presence of the parking spot or information concerning the parking spot. The vehicle can use wireless circuit 32 or other receiver to read the RFID tag and may then use this information to provide future guidance information to other vehicle-guidance application instances. For example, once the vehicle arrives and parks in a certain parking spot of the mapped location, the vehicle may read the RFID tag at the parking spot and may then send a notification to a server (e.g., computer 78 or server at remote facility 80) that indicates that the vehicle parked in the parking spot. This will allow an operator of a vehicle arriving at the mapped location to realize that the parking spot is occupied. In other embodiments, the parking spot may contain a sensor (e.g., an inductance loop detector) to detect the presence of the vehicle in a particular area or parking spot. Such information may be provided to a backend server, such as those that provide backend services to one or more vehicles or vehicle-guidance applications.

Moreover, the method above may be used when the vehicle is turned on (e.g., the ignition or other primary mover of the vehicle is started or enabled (a “vehicle ignition or primary mover enable event”)). The above method may then be used to guide a user from the parking spot or particular location to an exit of the mapped location.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

1. A method of directing a vehicle operator of a vehicle to a particular area within a mapped location, wherein the method is carried out by a mobile device, wherein the mobile device is associated and/or a part of the vehicle, and wherein the method comprises:
determining a location of the vehicle using one or more of the following:
signals from a global navigation satellite system (GNSS), short-range wireless communications, and/or cellular communication triangulation;
obtaining a layout of the mapped location, wherein the layout indicates one or more parking spots for the vehicle and/or one or more vehicle passageways;
determining at least one parking spot for the vehicle;
receiving video data of an area surrounding the vehicle;
displaying the video data on a visual display of the mobile device;
generating one or more graphics to present on the visual display, wherein the one or more graphics guide the operator at least partly from an entrance/exit of the mapped location to the at least one parking spot; and
displaying the one or more graphics over the camera feed on the visual display.

2. The method of claim 1, wherein the mobile device is a smartphone, a tablet, a wearable mobile device, or an electronic ocular device.

3. The method of claim 1, wherein the mobile device is the vehicle.

4. The method of claim 1, wherein the layout of the mapped location is an electronically-representative spatial model of the mapped location, and which includes one or more parking spots, passageways, and entrance/exit locations.

5. The method of claim 1, wherein the graphics are displayed over the camera feed such that an augmented reality view is provided to the operator and which acts to provide one or more navigational cues that direct the operator along certain passageways within the mapped location.

6. The method of claim 1, further comprising the step of obtaining vehicle sensor data, wherein the vehicle sensor data includes a vehicle speed and a vehicle direction, and wherein the one or more graphics are determined based on the obtained vehicle sensor data.

7. The method of claim 6, further comprising the step of determining a vehicle position within the mapped location using the vehicle sensor data and the electronically-representative spatial model.

8. The method of claim 1, further comprising the step of sensing a radio frequency identifier (RFID) tag and determining whether the RFID tag is associated with the at the at least one parking spot.

9. The method of claim 8, further comprising the step of detecting a vehicle ignition or primary mover enable event and, thereafter, carrying out the receiving steps and displaying steps of the method but wherein the one or more graphics guide the operator at least partly from the at least one parking spot to the entrance/exit of the mapped location.

10. A method of directing a vehicle operator of a vehicle to a particular area within a mapped location, wherein the method is carried out by a handheld mobile device, wherein the handheld mobile device is associated and/or a part of the vehicle, and wherein the method comprises:
determining that the vehicle is approaching an entrance of the mapped location using one or more of the following: signals from a global navigation satellite system (GNSS), short-range wireless communications, and/or cellular communication triangulation;
obtaining an electronically-representative spatial model of the mapped location, wherein the electronically-representative spatial model conveys spatial information of the mapped location including indications of one or more parking spots for the vehicle and/or one or more vehicle passageways;
obtaining information regarding the particular area, wherein the obtained information is based at least in part upon information particular to the vehicle;
receiving video data of an area surrounding the vehicle from the handheld mobile device, wherein the handheld mobile device is a set of vehicle electronics included in the vehicle or a personal handheld wireless device mounted within the vehicle, and wherein the handheld mobile device includes at least one camera and at least one visual display;
displaying the video data on the at least one visual display of the handheld mobile device;
obtaining vehicle sensor data, wherein the vehicle sensor data includes a vehicle speed and a vehicle direction;
determining a vehicle position within the mapped location using the vehicle sensor data and the electronically-representative spatial model;
generating one or more graphics to display on the visual display based on the vehicle position within the mapped location, wherein the one or more graphics operate to guide the vehicle operator at least partly from an entrance/exit of the mapped location to the particular area within the mapped location; and
displaying the one or more graphics over the camera feed on the visual display.

11. The method of claim 10, wherein the handheld mobile device is a smartphone, a tablet, a wearable mobile device, or an electronic ocular device.

12. The method of claim 10, wherein the electronically-representative spatial model of the mapped location indicates one or more parking spots, passageways, and entrance/exit locations.

13. The method of claim 10, wherein the graphics are displayed over the camera feed such that an augmented reality view is provided to the operator and which acts to provide one or more navigational cues that direct the operator along certain passageways within the mapped location.

14. The method of claim 13, wherein the one or more navigational cues indicate a direction for the vehicle operator to travel.

15. The method of claim 10, further comprising the step of sensing a radio frequency identifier (RFID) tag and determining whether the RFID tag is associated with the at the at least one parking spot.

16. The method of claim 10, further comprising the step of generating one or more graphics to display on the visual display based on the vehicle position within the mapped location, wherein the one or more graphics guide the operator at least partly from the at least one parking spot to the entrance/exit of the mapped location.
